(19) United States
(12) Patent Application Publication
(10) Pub. No.: US 2025/0388001 A1
(43) Pub. Date: Dec. 25, 2025

(54) TEMPORARY ADHESIVE LAYER, MULTILAYER STRUCTURE, TEMPORARY ADHESIVE COMPOSITION AND PACKAGING METHOD FOR DEVICE

(71) Applicant: Taichem Materials Co., Ltd., KAOHSIUNG CITY (TW)

(72) Inventors: Ming-Xue WEI, KAOHSIUNG CITY (TW); Jing-Ping WANG, KAOHSIUNG CITY (TW); Po-Wen LIN, KAOHSIUNG CITY (TW)

(21) Appl. No.: 19/248,443

(22) Filed: Jun. 24, 2025

(30) Foreign Application Priority Data
Jun. 25, 2024 (TW) 113123535

(51) Int. Cl. B32B 7/12; B32B 27/08; B32B 27/30

(52) U.S. Cl. CPC B32B 7/12; B32B 27/08; B32B 27/308; B32B 2250/03; B32B 2307/40; B32B 2307/7376; B32B 2457/14; B32B 2457/20

(57) ABSTRACT

The present disclosure relates to a temporary adhesive layer, a multilayer structure, a temporary adhesive composition, and a packaging method for a device. The temporary adhesive layer has a specific storage modulus after being heated. The temporary adhesive layer in the multi-layer structure has a specific complex viscosity. The temporary adhesive composition includes a specific proportion of composition. The obtained temporary adhesive composition has a specific complex viscosity. Therefore, the temporary adhesive composition has a certain degree of adhesion, can shield the laser and have the function of laser de-bonding. The method of device packaging includes a device formed by using the multi-layer structure.

### CROSS-REFERENCE TO RELATED APPLICATION

This application claims priority to Taiwan Application Serial Number 113123535, filed Jun. 25, 2024, which is herein incorporated by reference.

### BACKGROUND

### Field of Invention

The present disclosure relates to a temporary adhesive composition, a temporary adhesive layer, a multilayer structure, and a packaging method for a device.

### Description of Related Art

In conventional manufacturing methods for a semiconductor wafer, a laser de-bonding layer, a temporary adhesive layer, and a metal sacrificial layer are usually formed on a carrier wafer, and then a device wafer is disposed on the metal sacrificial layer (for example, a titanium/copper layer) for bonding. The metal sacrificial layer can block excess laser light from penetrating to the upper device wafer, and is used to protect the device wafer from damage. The laser de-bonding layer is used to separate the carrier wafer from the device wafer. The conventional laser de-bonding layer, temporary adhesive layer, and metal sacrificial layer have different compositions and must be formed by different processes. Therefore, the fabrication process of semiconductor wafer is time-consuming and costly.

### SUMMARY

The temporary adhesive layer of the present disclosure has a specific storage modulus after heating. Therefore, after laser de-bonding, the bonded device wafer can be peeled off smoothly.

The multilayer structure of the present disclosure includes the aforementioned temporary adhesive layer. The temporary adhesive layer has a specific complex viscosity. Therefore, the temporary adhesive layer has good gap-filling ability for the device wafer and bonds well with the device wafer. The structure of the multilayer structure is simple and can be applied to packaging methods in different fields.

The temporary adhesive composition of the present disclosure integrates multiple functions of laser shielding, laser de-bonding, and adhesion. The temporary adhesive composition includes a specific proportion of composition. The black dye in the temporary adhesive composition affects the light transmittance of the temporary adhesive composition, which can block excess laser light from penetrating to the upper device wafer, thereby shielding and protecting the upper device wafer. The base resin in the temporary adhesive composition has good high-temperature fluidity, so the temporary adhesive composition has good gap-filling ability for the device wafer. Furthermore, the base resin of the temporary adhesive composition has the function of laser de-bonding. The base resin and other resins in the temporary adhesive composition provide the temporary adhesive composition with appropriate viscosity, thereby achieving the function of adhering the carrier wafer and the device wafer.

The packaging method for a device of the present disclosure includes the device formed by the aforementioned multilayer structure. Since the single-layer temporary adhesive layer of the present disclosure integrates multiple functions of laser shielding, laser de-bonding, and adhesion, the device including the aforementioned temporary adhesive layer can be obtained without complicated processes, thereby reducing the process time and the process cost.

At least one embodiment of the present disclosure provides a temporary adhesive layer. A thickness of the temporary adhesive layer ranges from 2 μm to 2000 μm, a light transmittance at 300 nm to 1064 nm for the temporary adhesive layer ranges from 0.1% to 1%, and a storage modulus of the temporary adhesive layer is at least 0.1 MPa after the temporary adhesive layer is heated at 50° C. to 300° C. for at least 10 minutes, wherein an adhesion of the temporary adhesive layer to a substrate is greater than 180 N/cm².

In at least one embodiment of the present disclosure, the substrate is a copper substrate, a glass substrate, a polyimide substrate, or a silicon substrate.

In at least one embodiment of the present disclosure, a thermal degradation temperature (Td1) at 1% weight loss of the temporary adhesive layer is greater than 330° C.

In at least one embodiment of the present disclosure, an etch rate of the temporary adhesive layer in an alkaline cleaning solution ranges from 2.5 μm/min to 5.1 μm/min.

At least one embodiment of the present disclosure provides a multilayer structure. The multilayer structure includes a first release layer, a second release layer, and the aforementioned temporary adhesive layer. The temporary adhesive layer is disposed between the first release layer and the second release layer. The temporary adhesive layer has a first surface and a second surface that are opposite to each other, the first surface contacts the first release layer, and the second surface contacts the second release layer temporary. A complex viscosity of the adhesive layer is not greater than 940 Pa·s.

In at least one embodiment of the present disclosure, an absorption wavelength of the temporary adhesive layer ranges from 308 nm to 1064 nm.

In at least one embodiment of the present disclosure, there is no other layer between the temporary adhesive layer and the first release layer, and there is no other layer between the temporary adhesive layer and the second release layer.

At least one embodiment of the present disclosure provides a temporary adhesive composition used for forming the aforementioned temporary adhesive layer. Based on a total weight of the temporary adhesive composition as 100 weight percent (wt. %), the temporary adhesive composition includes 30 weight percent to 50 weight percent of a base resin, 17 weight percent to 40 weight percent of a hydrocarbon-based polymer resin, 0.1 weight percent to 20 weight percent of black dye, 0.5 weight percent to 4 weight percent of an imidazole-based curing agent, 0.5 weight percent to 5 weight percent of an anhydride-based curing agent, and 3 weight percent to 5 weight percent of an epoxy resin. The base resin is selected from the group consisting of an alkyd resin, a phenolic resin, an acrylic resin, and a polyester resin. A complex viscosity of the temporary adhesive composition is not greater than 940 Pa·s.

In at least one embodiment of the present disclosure, the acrylic resin is pentaerythritol triacrylate.

In at least one embodiment of the present disclosure, a hydroxyl value of the polyester resin is at least 20 mg KOH/g.

In at least one embodiment of the present disclosure, a molecular weight of the polyester resin is at least 5000 g/mole.

In at least one embodiment of the present disclosure, the polyester resin includes a benzene ring.

In at least one embodiment of the present disclosure, the polyester resin is a polyester polyol resin with a molecular weight of 5000 g/mole.

In at least one embodiment of the present disclosure, a particle diameter of the black dye ranges from 10 nm to 50 nm.

In at least one embodiment of the present disclosure, an absorption wavelength of the black dye ranges from 300 nm to 1064 nm.

At least one embodiment of the present disclosure provides a packaging method for a device, which includes the following steps. A first component is provided. A second component is provided. The aforementioned multilayer structure is provided, wherein the multilayer structure includes the first release layer, the second release layer, and the temporary adhesive layer. The first release layer of the multilayer structure is peeled off to expose the first surface of the temporary adhesive layer. After the first release layer is peeled off, a first lamination process is performed such that the first surface of the temporary adhesive layer is adhered to the first component. After the first lamination process is performed, the second release layer of the multilayer structure is peeled off to expose the second surface of the temporary adhesive layer. After the second release layer is peeled off, a second lamination process is performed such that the second surface of the temporary adhesive layer is adhered to the second component to obtain the device.

In at least one embodiment of the present disclosure, a lamination pressure of the first lamination process ranges from 0.5 kg/cm² to 100 kg/cm², a lamination temperature of the first lamination process ranges from 100° C. to 350° C., and a lamination time of the first lamination process ranges from 10 seconds to 200 minutes.

In at least one embodiment of the present disclosure, a lamination pressure of the second lamination process ranges from 0.5 kg/cm² to 100 kg/cm², a lamination temperature of the second lamination process ranges from 100° C. to 250° C., and a lamination time of the second lamination process ranges from 10 seconds to 200 minutes.

In at least one embodiment of the present disclosure, the first component is a carrier wafer, and the carrier wafer is a glass substrate, a silicon substrate, an organic substrate, or an inorganic substrate.

In at least one embodiment of the present disclosure, the second component is a device wafer, and the device wafer is an integrated substrate with molding compound or with an array copper pillar structure.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a multilayer structure according to some embodiments of the present disclosure.

FIG. 2 is a flowchart of a packaging method for a device according to some embodiments of the present disclosure.

FIG. 3A, FIG. 3B, and FIG. 3C are schematic diagrams illustrating packaging a first component and a second component in various steps according to some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

It will be understood that, although the terms “first,” “second,” etc. may be used herein to describe various elements, these elements should not be limited by these terms. These terms are only used to distinguish one element from another. For example, a “first element” may be termed a “second element,” and, similarly, a “second element” may be termed a “first element,” without departing from the scope of the embodiments.

In addition, while the method according to the present disclosure is illustrated and described below as a series of operations or steps, it will be appreciated that the illustrated ordering of such operations or steps are not to be interpreted in a limiting sense. For example, some operations or steps may occur in different orders and/or concurrently with other steps apart from those illustrated and/or described herein. Additionally, not all illustrated operations, steps and/or features can be required to implement one or more aspects or embodiments described herein. Also, each of the operations or steps disclosed herein may include several sub-steps or actions.

The disclosed temporary adhesive layer integrates multiple functions of laser shielding, laser de-bonding, and adhesion. The “laser shielding” mentioned herein means that when the laser light irradiates the temporary adhesive layer, the temporary adhesive layer can block a portion of the laser light, so that the device wafer far away from the laser light irradiation surface can be protected and prevented from being damaged. The “laser de-bonding” mentioned herein means that after the temporary adhesive layer is irradiated with the laser light, the temporary adhesive layer loses its viscosity due to chemical reactions, so that the carrier wafer at the lower layer and the device wafer can be separated.

The temporary adhesive layer of the present disclosure can be applied to manufacturing or packaging semiconductor devices or display devices. In other words, without the need for a conventional metal sacrificial layer and a conventional laser de-bonding layer, the single-layer temporary adhesive layer of the present disclosure integrates multiple functions of laser shielding, laser de-bonding, and adhesion. Specifically, compared with the conventional methods for manufacturing semiconductor devices or display devices, the method for manufacturing semiconductor devices or display devices of the present disclosure does not need to form the conventional metal sacrificial layer and the conventional laser de-bonding layer, so the method of the present disclosure can reduce the process time and the process cost.

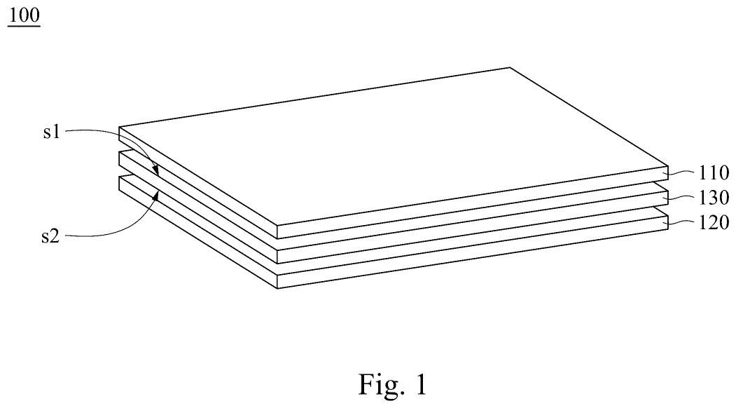

FIG. 1 is a schematic diagram of a multilayer structure 100 according to some embodiments of the present disclosure. The multilayer structure 100 includes a first release layer 110, a second release layer 120, and a temporary adhesive layer 130. The temporary adhesive layer 130 is disposed between the first release layer 110 and the second release layer 120. The temporary adhesive layer 130 has a first surface s1 and a second surface s2 that are opposite to each other. The first surface s1 of the temporary adhesive layer 130 contacts the first release layer 110, and the second surface s2 of the temporary adhesive layer 130 contacts the second release layer 120. The temporary adhesive layer 130 is sandwiched between the first release layer 110 and the second release layer 120.

In some embodiments, a thickness of the temporary adhesive layer 130 ranges from 2 μm to 2000 μm, such as 5, 10, 100, 150, 200, 250, 300, 500, 1000, 1500, or 1800 μm. If the thickness of the temporary adhesive layer 130 were less than 2 μm or greater than 2000 μm, the temporary adhesive layer 130 could not integrate multiple functions of laser shielding, laser de-bonding, and adhesion.

In some embodiments, a light transmittance at 300 nm to 1064 nm for the temporary adhesive layer 130 ranges from 0.1% to 1%, such as 0.3%, 0.5%, or 0.8%. If the light transmittance of the temporary adhesive layer 130 were greater than 1%, it could not prevent the device wafer from being damaged. If the light transmittance of the temporary adhesive layer 130 were less than 0.1%, it would mean that too much black dye had been added. As a result, the temporary adhesive layer 130 may have high roughness, poor adhesion, and poor gap-filling ability when softened at high temperatures. The function of the black dye will be described in detail below. It should be noted that the “gap-filling ability” mentioned herein means the capability of filling up the step-height structures (for examples, scribe lines) on the device wafer, wherein good gap-filling ability means that the step-height structures on the device wafer can be filled up a temporary adhesive composition (described in detail below).

In some embodiments, a storage modulus of the temporary adhesive layer 130 is at least 0.1 MPa after the temporary adhesive layer 130 is heated at 50° C. to 300° C. for at least 10 minutes. The storage modulus may be such as 1, 5, 10, or 12 MPa. If the temporary adhesive layer 130 does not have a certain rigidity after being heated (such as laminated), the temporary adhesive layer 130 will become flowable (i.e., reflow) during the laser irradiation process and then re-adhere to the device wafer, making it unable to separate the bonded device wafer. Therefore, if the storage modulus of the temporary adhesive layer 130 were less than 0.1 MPa, the temporary adhesive layer 130 could not be smoothly peeled off from the device wafer after laser irradiation, and residual adhesive may be adhered to the device wafer.

In some embodiments, an adhesion of the temporary adhesive layer 130 to a substrate is greater than 180 N/cm². If the adhesion of the temporary adhesive layer 130 to the substrate were less than 180 N/cm², the device wafer and the carrier wafer could not be sufficiently adhered. In other words, when the adhesion of the temporary adhesive layer 130 to the substrate is greater than 180 N/cm², it is beneficial to the subsequent process steps. In some specific examples, the adhesion of the temporary adhesive layer 130 to a copper (Cu) substrate is greater than 180 N/cm², such as about 300 N/cm². In some specific examples, the adhesion of the temporary adhesive layer 130 to a glass substrate is greater than 180 N/cm², such as about 193 N/cm². In some specific examples, the adhesion of the temporary adhesive layer 130 to a polyimide (PI) substrate is greater than 180 N/cm², such as about 358 N/cm². In some embodiments, the adhesion of the temporary adhesive layer 130 to a silicon substrate is greater than 180 N/cm², such as about 268 N/cm².

In some embodiments, a complex viscosity of the temporary adhesive layer 130 is not greater than 940 Pa·s, such as 20, 30, 100, 200, 300, 400, 500, 600, 700, 800, or 900 Pa·s. In a specific example, when the complex viscosity is less than 500 Pa-s, a line width of 2 μm in the device wafer can be filled. If the complex viscosity were greater than 940 Pa·s, the gap-filling ability for the device wafer could be poor, and thus the step-height structures of the device wafer could not be filled, thereby failing to bond well with the device wafer.

In some embodiments, a glass transition temperature (Tg) of the temporary adhesive layer 130 ranges from 80° C. to 200° C. If the glass transition temperature were less than 80° C., the viscosity of the temporary adhesive layer 130 would be too high, which would be detrimental to processes such as alignment. If the glass transition temperature were greater than 200° C., the temporary adhesive layer 130 would have poor fluidity when softened at high temperatures, so that the gap-filling ability would become poor, thereby the function of adhesion the device wafer and the carrier wafer might not be provided.

In some embodiments, a thermal degradation temperature (Td1) at 1% weight loss of the temporary adhesive layer 130 is greater than 330° C., such as 333° C. If Td1 were less than 330° C., the temporary adhesive layer 130 would be decomposed during the manufacturing processes (such as solder reflow or chemical vapor deposition) due to insufficient heat resistance, resulting in wafer shattering.

In some embodiments, an absorption wavelength of the temporary adhesive layer 130 ranges from 308 nm to 1064 nm, such as 355 nm or 532 nm. When the absorption wavelength of the temporary adhesive layer 130 is in the above range, the temporary adhesive layer 130 has the multifunction of laser shielding, laser de-bonding, and adhesion.

The temporary adhesive composition of the present disclosure is provided, wherein the temporary adhesive composition is used for forming the aforementioned temporary adhesive layer 130. Based on a total weight of the temporary adhesive composition as 100 weight percent, the temporary adhesive composition includes 30 weight percent to 50 weight percent of a base resin, 17 weight percent to 40 weight percent of a hydrocarbon-based polymer resin, 0.1 weight percent to 20 weight percent of black dye, 0.5 weight percent to 4 weight percent of a imidazole-based curing agent, 0.5 weight percent to 5 weight percent of an anhydride-based curing agent, and 3 weight percent to 5 weight percent of an epoxy resin.

In some embodiments, the base resin is selected from the group consisting of an alkyd resin, a phenolic resin, an acrylic resin, and a polyester resin. In some embodiments, the acrylic resin may be, for example, pentaerythritol triacrylate (product: ETERMER 235, manufactured by Eternal Materials Co., Ltd.). In some embodiments, the polyester resin may be, for example, a polyester resin including a benzene ring (product: HE558/40 with a molecular weight of 18000 (referred to as “HE-558” in Tables 1 to 3), manufactured by An Fong Development Co., Ltd.), the polyester resin (product: HE554/40 (referred to as “HE-554” in Table 1), manufactured by An Fong Development Co., Ltd.), a polyester polyol resin (product: SANNIX KC-229 with a molecular weight of 5000 g/mole (referred to as “KC-229” in Table 1), manufactured by Sanyo Chemical Industries, Ltd.). In some embodiments, a hydroxyl value of the polyester resin is at least 20 mg KOH/g, such as 25, 30, 35, or 40 mg KOH/g. In some embodiments, the base resin includes a compound having a benzene ring structure. The benzene ring in the base resin exhibits absorption peaks in the ultraviolet range (for example, 220 nm to 400 nm). On the one hand, when the benzene ring absorbs energy, it will produce free radicals, which will break the bonds of the functional groups, thereby achieving the function of laser de-bonding. On the other hand, under high laser temperature, the continuous phase of the base resin will be weakened and partially decomposed, thereby achieving the function of laser de-bonding. In other words, the base resin in the temporary adhesive composition has the function of laser de-bonding.

In some embodiments, the base resin is a thermoplastic resin. The disclosed base resin has good high-temperature fluidity and therefore has good gap-filling capability for the device wafer, thereby the temporary adhesive composition can bond well with the device wafer. In some embodiments, a complex viscosity of the temporary adhesive composition is not greater than 940 Pa·s, such as 20, 30, 100, 200, 300, 400, 500, 600, 700, 800, or 900 Pa·s. It should be noted that the “high-temperature fluidity” herein means that the temporary adhesive composition has a certain complex viscosity at high temperatures and has a certain degree of fluidity.

In some embodiments, a molecular weight of the polyester resin is at least 5000 g/mole, such as about 15000 g/mole or about 20000 g/mole. If the molecular weight of the polyester resin were less than 5000 g/mole, it would be detrimental to the gap-filling ability for narrow and fine line widths of the wafer structures because the complex viscosity of the temporary adhesive composition at high temperatures is inversely proportional to the molecular weight. In addition, the temporary adhesive composition may have poor adhesion, so that the temporary adhesive composition could not properly bond the carrier wafer and the device wafer. Furthermore, if the molecular weight of the polyester resin were less than 5000 g/mole, due to its higher glass transition temperature (Tg), higher temperature lamination conditions would be required during the process, which would be prone to cause wafer warpage due to mismatch in thermal expansion coefficients.

In some embodiments, the temporary adhesive composition includes 35, 40, or 45 weight percent of the base resin. If the content of the base resin were less than 30 weight percent, the rigidity of the temporary adhesive composition would be too high, and the adhesion between the device wafer and carrier wafer would be insufficient, making it easily separate from each other during the process. In addition, the high-temperature fluidity may be poor, which may be detrimental to fill the step-height structures of the device wafer. If the content of the base resin were greater than 50 weight percent, the temporary adhesive composition would cause colloidal adhesion around the device wafer, making it unable to separate the device wafer from the carrier wafer.

The hydrocarbon-based polymer resin in the temporary adhesive composition provides rigidity to the temporary adhesive composition after cross-linking reaction, so as to enhance the dimensional stability of the obtained temporary adhesive layer after lamination during the manufacturing process. In addition, in some embodiments, since the hydrocarbon-based polymer resin has a functional group that can react with the hydroxyl group (—OH group) of the base resin to form a urethane functional group (such as an isocyanate functional group), it can react with an alkaline cleaning solution and is easy to be cleaned after the laser de-bonding process. In some embodiments, the hydrocarbon-based polymer resin may include aliphatic isocyanates, for example, product REXIN 1973/900, manufactured by An Fong Development Co., Ltd. In some embodiments, an etch rate of the temporary adhesive layer in the alkaline cleaning solution ranges from 2.5 μm/min to 5.1 μm/min. In some embodiments, the temporary adhesive composition includes 20, 25, 30, or 35 weight percent of the hydrocarbon-based polymer resin. If the content of the hydrocarbon-based polymer resin were less than 17 weight percent, the etch rate of the temporary adhesive layer in the alkaline cleaning solution would be greatly reduced. If the content of the hydrocarbon-based polymer resin were greater than 40 weight percent, the complex viscosity of the temporary adhesive composition at high temperatures would be too high, thereby affecting the gap-filling ability for the device wafer and the adhesion of the temporary adhesive layer to the substrate (for example, the copper substrate).

The black dye in the temporary adhesive composition provides the temporary adhesive layer with the function of laser shielding, so that the light transmittance of the temporary adhesive layer ranges from 0.1% to 1%. Specifically, the temporary adhesive layer is used to bond the carrier wafer and the device wafer. In other words, the temporary adhesive layer is disposed between the carrier wafer and the device wafer. The structure including the carrier wafer, the temporary adhesive layer, and the device wafer is used for performing the process of manufacturing the device wafer. Then, after the process of manufacturing the device wafer, laser light is irradiated from the carrier wafer side (i.e., laser de-bonding) to obtain a separated device wafer. During the laser irradiation process, the temporary adhesive layer including the black dye can protect the device wafer from damage by laser irradiation.

It should be noted that the addition of the black dye will increase the roughness of the temporary adhesive composition, so that the contact area between the temporary adhesive composition and the substrate (for example, the carrier wafer) becomes smaller, thereby affecting the adhesion of the temporary adhesive layer. In other words, the shielding ability of the black dye is inversely proportional to the roughness. Specifically, the more the black dye is added, the better the shielding ability for the device wafer becomes, but the roughness of the temporary adhesive composition becomes higher such that the adhesion of the temporary adhesive composition to the device wafer becomes worse. On the contrary, the less the black dye is added, the weaker the shielding ability for the device wafer becomes, but the roughness of the temporary adhesive composition becomes lower such that the adhesion of the temporary adhesive composition to the device wafer becomes better. In addition, the addition of black dye will also affect the gap-filling ability of the temporary adhesive composition when it softens at high temperatures. Specifically, as the content of black dye added increases, the gap-filling ability of the temporary adhesive composition may become poor when the temporary adhesive composition is softened at high temperatures. Therefore, an appropriate content of black dye needs to be added so that the temporary adhesive composition has appropriate adhesion and gap-filling ability.

In some embodiments, the temporary adhesive composition includes 0.2, 0.5, 0.8, 1, 3.5, 3.9, 4, 6, 8, 10, 12, 14, 16, or 18 weight percent of the black dye. If the content of black dye were less than 0.1 weight percent, the shielding ability of the temporary adhesive layer formed by the temporary adhesive composition would be insufficient to protect the device wafer from damage. If the content of the black dye were greater than 20 weight percent, although the device wafer could be protected from damage, the roughness of the temporary adhesive composition would increase, which would reduce the adhesion of the temporary adhesive layer to the substrate, thereby failing to fully adhere the device wafer and the carrier wafer. In addition, if the content of the black dye were greater than 20 weight percent, it would also affect the total thickness variation (TTV) (i.e., the flatness) of the temporary adhesive layer, which might not be conducive to operation (for example, increasing the risk of die misalignment).

In some embodiments, the black dye may be, for example, carbon black. In some embodiments, a particle diameter of the black dye ranges from 10 nm to 50 nm, such as 20, 30, or 40 nm. If the particle diameter of the black dye were less than 10 nm, agglomeration could occur during dispersion in the temporary adhesive composition due to the black dye has a large surface area. If the particle diameter of the black dye were greater than 50 nm, the influence of gravity would increase, causing sedimentation problems.

In some embodiments, an absorption wavelength of the black dye ranges from 300 nm to 1064 nm. When the absorption wavelength of the black dye is in the above range, the temporary adhesive composition has the multifunction of laser shielding, laser de-bonding, and adhesion.

The addition of the imidazole-based curing agent can react with the epoxy resin in the temporary adhesive composition to adjust the surface adhesion (g/cm²) in the incompletely cross-linked state (B-Stage). In some embodiments, the temporary adhesive composition includes 0.8, 1, 2, or 3 weight percent of the imidazole-based curing agent. If the content of the imidazole-based curing agent were less than 0.5 weight percent, the temporary adhesive composition prior to curing would have a relatively higher adhesion. If the device wafer and the carrier wafer accidentally contacted the temporary adhesive composition during the alignment step, unintended sticking would occur, thereby increasing the difficulty of operation. If the content of the imidazole-based curing agent were greater than 4 weight percent, the excess imidazole-based curing agent would cause the thermal degradation temperature of the temporary adhesive layer to be less than 330° C., and the imidazole-based curing agent unreacted in the reaction would gasify during the high-temperature process, which would lead to wafer shattering.

The addition of the anhydride-based curing agent can increase the degree of the crosslinking of the temporary adhesive composition to enhance the heat resistance. In some embodiments, the temporary adhesive composition includes 0.8, 1, 2, 3, or 4 of the anhydride-based curing agent. If the content of the anhydride-based curing agent were less than 0.5 weight percent, the degree of the crosslinking of the temporary adhesive composition would be insufficient, which would be prone to cause wafer shattering during the manufacturing process. If the content of the anhydride-based curing agent were greater than 5 weight percent, the excess anhydride-based curing agent unreacted in the reaction would cause the thermal degradation temperature of the temporary adhesive layer to be less than 330° C.

The addition of the epoxy resin can adjust the surface adhesion of the temporary adhesive composition that has not been fully cured, and can reduce the fluidity of the temporary adhesive composition after curing. In some embodiments, the temporary adhesive composition includes 3.5, 4, or 4.5 weight percent of the epoxy resin. If the content of the epoxy resin were less than 3 weight percent, the temporary adhesive composition prior to curing would have a relatively higher adhesion. If the device wafer and the carrier wafer accidentally come into contact with the temporary adhesive composition during the alignment process, adhesion would be likely to occur, increasing the difficulty of the process. In addition, if the content of the epoxy resin were insufficient, the heat generated during the manufacturing process would cause the cured temporary adhesive layer to become flowable, making it difficult to separate the carrier wafer and the device wafer. If the content of the epoxy resin were greater than 5 weight percent, the thermal degradation temperature of the temporary adhesive layer would be less than 330° C., and the wafer would be shattered during the manufacturing process due to its insufficient heat resistance.

Referring to FIG. 1, in some embodiments, a first surface s1 of the temporary adhesive layer 130 directly contacts the first release layer 110, and a second surface s2 of the temporary adhesive layer 130 directly contacts the second release layer 120. In other words, there is no other layer between the temporary adhesive layer 130 and the first release layer 110, and there is no other layer between the temporary adhesive layer 130 and the second release layer 120.

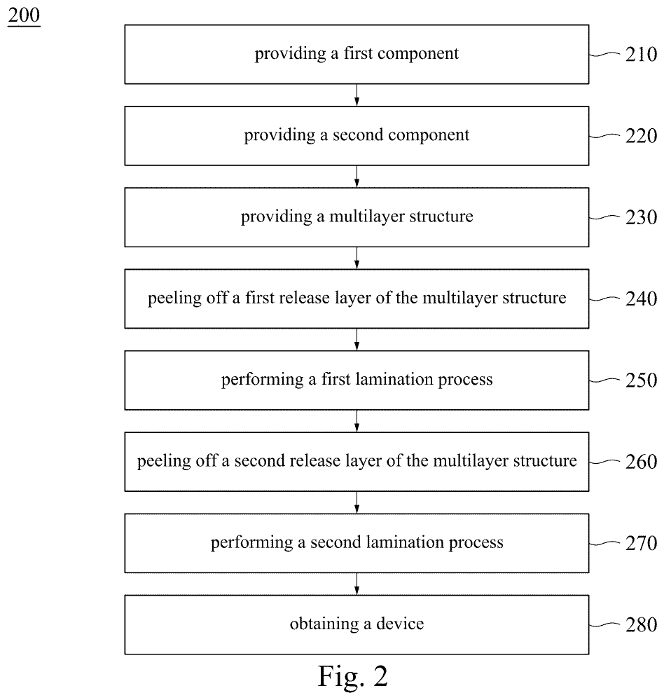

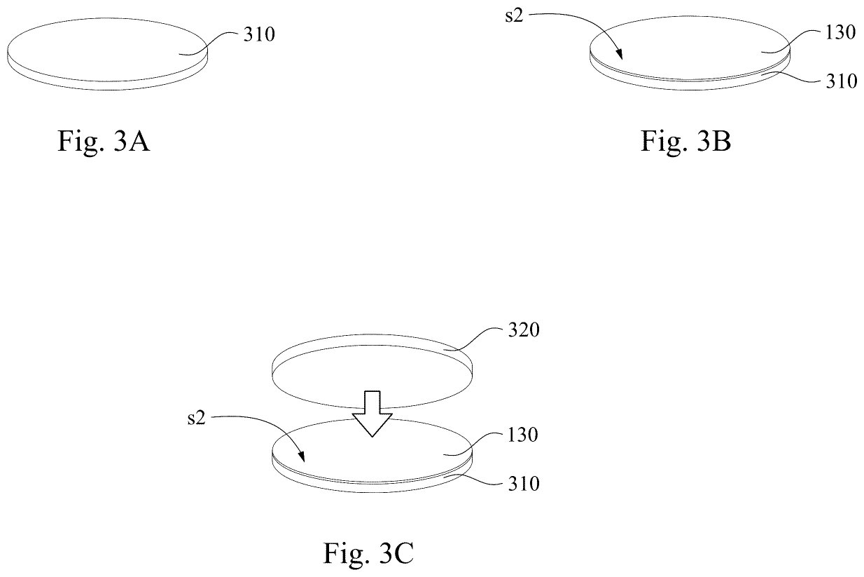

FIG. 2 is a flowchart of a packaging method 200 for a device according to some embodiments of the present disclosure. FIG. 3A, FIG. 3B, and FIG. 3C are schematic diagrams illustrating packaging a first component and a second component in various steps according to some embodiments of the present disclosure.

The packaging method 200 for the device includes the following steps. Referring to a step 210 in FIG. 2 and FIG. 3A, providing a first component 310. The first component 310 may be, for example, a carrier wafer. For examples, the carrier wafer may be a glass substrate, a silicon substrate, an organic substrate, or an inorganic substrate, but is not limited thereto.

Referring to a step 220 in FIG. 2 and FIG. 3C, providing a second component 320. The second component 320 may be, for example, a device wafer. For examples, the device wafer may be an integrated substrate with molding compound or an integrated substrate with an array copper pillar structure, but is not limited thereto. The molding compound may be, for example, epoxy molding compound (EMC).

Referring to a step 230 in FIG. 2 and FIG. 1, providing the multilayer structure 100.

Referring to a step 240 in FIG. 2 and FIG. 1, peeling off the first release layer 110 of the multilayer structure 100 to expose the first surface s1 of the temporary adhesive layer 130.

Referring to a step 250 in FIG. 2 and FIG. 1, after peeling off the first release layer 110, performing a first lamination process such that the first surface s1 of the temporary adhesive layer 130 is adhered to the first component 310 (referring to FIG. 3A).

In some embodiments, a lamination pressure of the first lamination process ranges from 0.5 kg/cm² to 100 kg/cm², such as 1, 10, 20, 50, 80 kg/cm². In some embodiments, a lamination temperature of the first lamination process ranges from 100° C. to 350° C., such as 150° C., 200° C., 250° C., or 300° C. In some embodiments, a lamination time of the first lamination process ranges from 10 seconds to 200 minutes, such as 30 seconds, 1 minute, 10 minutes, 50 minutes, 100 minutes, or 150 minutes. When the lamination pressure, the lamination temperature, and the lamination time are in the above ranges, the temporary adhesive layer 130 can be adhered to the first component 310 without insufficient flatness or gaps between the temporary adhesive layer 130 and the first component 310 due to uneven lamination, thereby avoiding the separation of the temporary adhesive layer 130 and the first component 310 due to gas expansion during the high-temperature process.

Referring to a step 260 in FIG. 2, FIG. 1, and FIG. 3B, after performing the first lamination process, peeling off the second release layer 120 of the multilayer structure 100 to expose the second surface s2 of the temporary adhesive layer 130.

Referring to a step 270 and a step 280 in FIG. 2, FIG. 1, and FIG. 3C, after peeling off the second release layer 120, performing a second lamination process such that the second surface s2 of the temporary adhesive layer 130 is adhered to the second component 320 to obtain the device. It could be understood that the device is a sandwich structure in which the temporary adhesive layer 130 is sandwiched between the first component 310 and the second component 320, wherein the temporary adhesive layer 130 is a single-layer temporary adhesive, as shown in FIG. 3C. The “device” mentioned herein may be, for example, a semiconductor device or a display device.

In some embodiments, a lamination pressure of the second lamination process ranges from 0.5 kg/cm² to 100 kg/cm², such as 1, 10, 20, 50, or 80 kg/cm². In some embodiments, a lamination temperature of the second lamination process ranges from 100° C. to 250° C., such as 150° C. or 200° C. In some embodiments, a lamination time of the second lamination process ranges from 10 seconds to 200 minutes, such as 30 seconds, 1 minute, 10 minutes, 50 minutes, 100 minutes, or 150 minutes. When the lamination pressure, the lamination temperature, and the lamination time in the above ranges, the temporary adhesive layer 130 can be adhered to the second component 320 without insufficient flatness or gaps between the temporary adhesive layer 130 and the second component 320 due to uneven lamination, thereby avoiding the separation of the temporary adhesive layer 130 and the second component 320 due to gas expansion during the high-temperature process.

In some embodiments, after the device of FIG. 3C is formed, wafer fabrication can be selectively performed on the second component 320. After the wafer fabrication is completed, a laser de-bonding step can be selectively performed on the device of FIG. 3C, such that the second component 320 is separated from the device. The “laser de-bonding” mentioned herein refers to irradiating the first component 310 side of the device with laser light to break the temporary adhesive layer 130, thereby separating the second component 320.

By using the above-mentioned embodiments as shown in FIG. 1 and FIG. 2, the temporary adhesive layer 130 of the present disclosure can be adhered to the first component 310. However, in other embodiments, the temporary adhesive composition of the present disclosure can be coated on the first component 310 by spin coating.

Referring to Table 1 to Table 3 below, Experimental Examples 1 to 18 and Comparative Examples 1 to 12 were used to describe the application of the present disclosure. However, they are not intended to limit the present disclosure. Those skilled in the art may make various changes and alterations without departing from the spirit and scope of the present disclosure.

### Experimental Example 1

In Experimental Example 1, the temporary adhesive composition included 30 weight percent of the base resin, 25 weight percent of the hydrocarbon-based polymer resin, 10 weight percent of the black dye, 4 weight percent of the epoxy resin, 1 weight percent of the imidazole-based curing agent, and 1 weight percent of the anhydride-based curing agent, wherein the base resin was HE-558 and the black dye was carbon black. The evaluation results of the obtained temporary adhesive composition were shown in Table 1 below.

### Experimental Examples 2 to 18 and Comparative Examples 1 to 12

The temporary adhesive compositions and evaluation results of Experimental Examples 2 to 18 and Comparative Examples 1 to 12 were shown in Tables 1 to 3, wherein particle diameters of the black dye were shown in Table 3. It should be noted that the black dye in the compositions of Experimental Examples 2 to 18 and Comparative Examples 1 to 12 was carbon black.

### Evaluation Methods

1. De-Bonding Capability after Laser Irradiation

The de-bonding capability after laser irradiation of the present disclosure was measured by using Diode-Pumped Solid-State Laser (DPSS Laser) with a wavelength of 355 nm, wherein a distance between a laser source and the substrate was fixed at 1500 mm, a spot size was 65 μm, a pitch was 48 μm, and power was 2.0 W, to evaluate whether the temporary adhesive composition of Experimental Examples 1 to 15 and Comparative Examples 1 to 10 was de-bonded after laser irradiation. The measurement results were shown in Table 1 and Table 2 below.

2. Evaluation of Device Wafer Damage after Laser Irradiation

The device wafer damage after laser irradiation of the present disclosure was evaluated by performing laser de-bonding as described above, followed by observation of the device wafer surface using an optical microscope to determine whether any damage had occurred. The measurement results of Experimental Examples 1 to 18 and Comparative Examples 1 to 12 were shown in Table 1 to Table 3 below.

### 3. Adhesion Evaluation on Cu Substrate

The adhesion on the Cu substrate of the present disclosure was evaluated by using the MIL-STD-883 (Method 2027) standard, using a rivet to test the adhesion of the temporary adhesive composition to the copper substrate surface. A 4 cm×4 cm of evaporated copper substrate was cut, and the film made from the temporary adhesive composition was laminated onto the copper substrate using a vacuum hot press to prepare a test sample. Subsequently, a clamp was used to fix the rivet onto the surface of the test sample, which was then placed in a 160° C. oven for 1 hour to soften the epoxy resin on the rivet surface. After removing the clamp, a tensile force of 4.0 N/sec was applied to the rivet to determine the conditions required to separate the temporary adhesive composition from the copper substrate surface. This test was used to measure the adhesion of the temporary adhesive compositions from Experimental Examples 1 to 18 and Comparative Examples 1 to 12 to the Cu substrate, expressed in units of N/cm². The measurement results were shown in Table 1 to Table 3 below.

### 4. Evaluation of Etch Rate in Alkaline Cleaning Solution

The etch rate in the alkaline cleaning solution of the present disclosure was evaluated by first laminating the temporary adhesive layer onto a glass substrate using the vacuum hot press, followed by complete curing in an oxygen-free oven. The etch rates of the temporary adhesive compositions from Experimental Examples 1 to 15 and Comparative Examples 1 to 10 were then evaluated in the alkaline cleaning solution containing 2.38% TMAH at 60° C. The etch rate was expressed in units of μm/min. The measurement results were shown in Table 1 and Table 2 below.

### 5. Evaluation of Complex Viscosity

The complex viscosity of the present disclosure was evaluated using an HR-2 rotational rheometer (manufactured by TA Instruments) in accordance with the standard method ASTM (American Society for Testing and Materials) D4440. The test was conducted to evaluate the complex viscosity of the temporary adhesive compositions from Experimental Examples 1 to 15 and Comparative Examples 1 to 10. The results were expressed in units of Pa·s. The measurement results were shown in Table 1 and Table 2 below.

### 6. Evaluation of Surface Adhesion Prior to Complete Curing

The surface adhesion prior to complete curing of the present disclosure was evaluated in accordance with the standard method ASTM D3330. A 180° peel test was performed between the temporary adhesive composition and an overlying laminated film (such as, a release film) to assess the surface adhesion prior to complete curing. This evaluation was conducted for the temporary adhesive compositions from Experimental Examples 1 to 15 and Comparative Examples 1 to 10. The results were expressed in units of g/cm².

### 7. Evaluation of 1% Thermal Decomposition Temperature (Td1)

The 1% thermal degradation temperature of the present disclosure was evaluated using a thermogravimetric analyzer (TGA, manufactured by TA Instruments, model: Q-500) in accordance with the standard method ASTM E2550-21. The sample weight was maintained between 5 and 10 mg, and the test was performed under a nitrogen (N₂) atmosphere with a heating rate of 10° C. per minute. This evaluation was conducted for the temporary adhesive compositions from Experimental Examples 1 to 15 and Comparative Examples 1 to 10. The results were expressed in degrees Celsius (° C.). The measurement results were shown in Table 1 and Table 2 below.

TABLE 1

| Experimental Example | 1 | 2 | 3 | 4 | 5 | 6 | 7 | 8 |
|---|---|---|---|---|---|---|---|---|
| base resin (wt. %) | 30 | 35 | 50 | 35 | 35 | 35 | 35 | 35 |
| base resin type | HE-558 | HE-558 | HE-558 | HE-554 | HE-554 | HE-554 | KC-229 | KC-229 |
| hydrocarbon-based | 25 | 25 | 25 | 17 | 25 | 40 | 25 | 25 |
| polymer resin (wt. %) | | | | | | | | |
| epoxy resin (wt. %) | 4 | 4 | 4 | 4 | 4 | 4 | 3 | 4 |
| imidazole-based curing | 1 | 1 | 1 | 1 | 1 | 1 | 1 | 1 |
| agent (wt. %) | | | | | | | | |
| anhydride-based curing | 1 | 1 | 1 | 1 | 1 | 1 | 1 | 1 |
| agent (wt. %) | | | | | | | | |
| black dye (wt. %) | 10 | 10 | 10 | 10 | 10 | 10 | 10 | 10 |
| whether temporary | Yes | Yes | Yes | Yes | Yes | Yes | Yes | Yes |
| adhesive composition | | | | | | | | |
| was de-bonded after | | | | | | | | |
| laser irradiation | | | | | | | | |
| whether device wafer | No | No | No | No | No | No | No | No |
| was damaged after | | | | | | | | |
| laser irradiation | | | | | | | | |
| adhesion on Cu | 180 | 244 | 308 | 298 | 244 | 231 | 243 | 244 |
| substrate (N/cm²) | | | | | | | | |
| etch rate in alkaline | 3.3 | 3.4 | 3.4 | 2.5 | 3.4 | 5.1 | 3.4 | 3.4 |
| cleaning solution | | | | | | | | |
| (μm/min) | | | | | | | | |
| complex viscosity | 940 | 693 | 354 | 374 | 693 | 838 | 695 | 693 |
| (Pa · s) | | | | | | | | |
| surface adhesion prior | 1.8 | 1.8 | 1.8 | 1.8 | 1.8 | 1.8 | 2 | 1.8 |
| to complete curing | | | | | | | | |
| (g/cm²) | | | | | | | | |
| 1% thermal | 374 | 371 | 370 | 371 | 371 | 371 | 375 | 371 |
| decomposition | | | | | | | | |
| temperature (Td1) | | | | | | | | |

| Experimental Example | 9 | 10 | 11 | 12 | 13 | 14 | 15 |
|---|---|---|---|---|---|---|---|
| base resin (wt. %) | 35 | 35 | 35 | 35 | 35 | 35 | 35 |
| base resin type | KC-229 | HE-558 | HE-558 | HE-558 | HE-558 | HE-558 | HE-558 |
| hydrocarbon-based | 25 | 25 | 25 | 25 | 25 | 25 | 25 |
| polymer resin (wt. %) | | | | | | | |
| epoxy resin (wt. %) | 5 | 4 | 4 | 4 | 4 | 4 | 4 |
| imidazole-based curing | 1 | 0.5 | 2 | 4 | 1 | 1 | 1 |
| agent (wt. %) | | | | | | | |
| anhydride-based curing | 1 | 1 | 1 | 1 | 0.5 | 3 | 5 |
| agent (wt. %) | | | | | | | |
| black dye (wt. %) | 10 | 10 | 10 | 10 | 10 | 10 | 10 |
| whether temporary | Yes | Yes | Yes | Yes | Yes | Yes | Yes |
| adhesive composition | | | | | | | |
| was de-bonded after | | | | | | | |
| laser irradiation | | | | | | | |
| whether device wafer | No | No | No | No | No | No | No |
| was damaged after | | | | | | | |
| laser irradiation | | | | | | | |
| adhesion on Cu | 244 | 244 | 243 | 243 | 242 | 243 | 241 |
| substrate (N/cm²) | | | | | | | |
| etch rate in alkaline | 3.3 | 3.4 | 3.4 | 3.4 | 3.4 | 3.4 | 3.4 |
| cleaning solution | | | | | | | |
| (μm/min) | | | | | | | |
| complex viscosity | 694 | 693 | 693 | 691 | 692 | 691 | 693 |
| (Pa · s) | | | | | | | |
| surface adhesion prior | 1.7 | 2.3 | 1.7 | 1.5 | 2 | 1.6 | 1.5 |
| to complete curing | | | | | | | |
| (g/cm²) | | | | | | | |
| 1% thermal | 340 | 337 | 370 | 341 | 330 | 358 | 334 |
| decomposition | | | | | | | |
| temperature (Td1) | | | | | | | |

TABLE 2

| Comparative Example | 1 | 2 | 3 | 4 | 5 | 6 | 7 | 8 | 9 | 10 |
|---|---|---|---|---|---|---|---|---|---|---|
| base resin (wt. %) | 29 | 51 | 35 | 35 | 35 | 35 | 35 | 35 | 35 | 35 |
| base resin type | HE-558 | HE-558 | HE-558 | HE-558 | HE-558 | HE-558 | HE-558 | HE-558 | HE-558 | HE-558 |
| hydrocarbon-based | 25 | 25 | 16 | 41 | 25 | 25 | 25 | 25 | 25 | 25 |
| polymer resin (wt. %) | | | | | | | | | | |
| epoxy resin (wt. %) | 4 | 4 | 4 | 4 | 1 | 6 | 4 | 4 | 4 | 4 |
| imidazole-based | 1 | 1 | 1 | 1 | 1 | 1 | 0.4 | 5 | 1 | 1 |
| curing agent (wt. %) | | | | | | | | | | |
| anhydride-based | 1 | 1 | 1 | 1 | 1 | 1 | 1 | 1 | 0.4 | 5.5 |
| curing agent (wt. %) | | | | | | | | | | |
| black dye (wt. %) | 10 | 10 | 10 | 10 | 10 | 10 | 10 | 10 | 10 | 10 |
| whether temporary | Yes | No | Yes | Yes | No | Yes | No | Yes | Yes | Yes |
| adhesive composition | | | | | | | | | | |
| was de-bonded after | | | | | | | | | | |
| laser irradiation | | | | | | | | | | |
| whether device wafer | No | No | No | No | No | No | No | No | No | No |
| was damaged after laser | | | | | | | | | | |
| irradiation | | | | | | | | | | |
| adhesion on Cu | 87 | 325 | 287 | 167 | 248 | 244 | 243 | 243 | 240 | 243 |
| substrate (N/cm²) | | | | | | | | | | |
| etch rate in alkaline | 3.3 | 3.4 | 1.2 | 5.1 | 3.4 | 3.4 | 3.4 | 3.4 | 3.4 | 3.4 |
| cleaning solution | | | | | | | | | | |
| (μm/min) | | | | | | | | | | |
| complex viscosity (Pa · s) | 1549 | 354 | 364 | 1064 | 695 | 690 | 690 | 703 | 690 | 692 |
| surface adhesion prior to | 1.8 | 1.8 | 1.8 | 1.8 | 2.9 | 1.6 | 2.5 | 1.5 | 2.5 | 1.5 |
| complete curing (g/cm²) | | | | | | | | | | |
| 1% thermal | 374 | 370 | 370 | 371 | 375 | 301 | 313 | 323 | 321 | 301 |
| decomposition | | | | | | | | | | |
| temperature (Td1) | | | | | | | | | | |

TABLE 3

| | Experimental | Experimental | Experimental | Experimental | Comparative | Comparative |
|---|---|---|---|---|---|---|
| | Example 16 | Example 2 | Example 17 | Example 18 | Example 11 | Example 12 |
| base resin (wt. %) | 35 | 35 | 35 | 35 | 35 | 35 |
| base resin type | HE-558 | HE-558 | HE-558 | HE-558 | HE-558 | HE-558 |
| hydrocarbon-based | 25 | 25 | 25 | 25 | 25 | 25 |
| polymer resin (wt. %) | | | | | | |
| epoxy resin (wt. %) | 4 | 4 | 4 | 4 | 4 | 4 |
| imidazole-based | 1 | 1 | 1 | 1 | 1 | 1 |
| curing agent (wt. %) | | | | | | |
| anhydride-based | 1 | 1 | 1 | 1 | 1 | 1 |
| curing agent (wt. %) | | | | | | |
| black dye (wt. %) | 0.1 | 10 | 10 | 20 | 0.05 | 21 |
| particle diameter of | 30 | 10 | 50 | 10 | 10 | 10 |
| black dye (nm) | | | | | | |
| whether device wafer | No | No | No | No | Yes | No |
| was damaged after | | | | | | |
| laser irradiation | | | | | | |
| adhesion on Cu | 280 | 244 | 240 | 180 | 281 | 162 |
| substrate (N/cm²) | | | | | | |

As shown in Comparative Example 1, when the content of the base resin was less than 30 weight percent, the temporary adhesive layer formed from the temporary adhesive composition exhibited insufficient adhesion to the copper substrate, making it unable to adequately bond the device wafer to the carrier wafer. In addition, due to the insufficient content of the base resin, the complex viscosity of the temporary adhesive composition became too high, resulting in poor gap-filling capability. As shown in Comparative Example 2, when the content of the base resin was greater than 50 weight percent, the temporary adhesive composition caused colloidal adhesion around the device wafer, making it unable to separate the device wafer from the carrier wafer after the laser de-bonding process.

As shown in Comparative Example 3, when the content of the hydrocarbon-based polymer resin was less than 17 weight percent, the etch rate of the temporary adhesive composition was too slow, meaning it is less easily removed by the alkaline cleaning solution. As shown in Comparative Example 4, when the content of the hydrocarbon-based polymer resin was greater than 40 weight percent, the complex viscosity of the temporary adhesive composition at high temperatures was too high, thereby affecting the gap-filling ability for the device wafer and the adhesion of the temporary adhesive layer to the copper substrate (for example, less than 180 N/cm²).

As shown in Comparative Example 5, when the content of the epoxy resin was less than 3 weight percent, the adhesion of the temporary adhesive composition prior to curing was too high (for example, greater than 2.3 g/cm²). During the manufacturing process, accidental contact between the device wafer and the carrier wafer during the alignment step led to unintended sticking, thereby increasing the difficulty of operation. In addition, when the content of the epoxy resin was insufficient, the heat generated during the manufacturing process caused the cured temporary adhesive composition to become flowable, resulting in re-adhesion between the carrier wafer and the device wafer after the laser de-bonding process, making it unable to separate the bonded device wafer. As shown in Comparative Example 6, when the content of the epoxy resin was greater than 5 weight percent, the excess small molecules of epoxy resin did not react completely with the curing agent, resulting in the thermal degradation temperature of less than 330° C., which would easily cause wafer shattering during the manufacturing process.

As shown in Comparative Examples 7 and 9, when the content of the imidazole-based curing agent was less than 0.5 weight percent or the content of the anhydride-based curing agent was less than 0.5 weight percent, the temporary adhesive compositions prior to curing had higher surface adhesion (for examples, greater than 2.3 g/cm²). During the manufacturing process, accidental contact between the device wafer and the carrier wafer during the alignment step led to unintended sticking, thereby increasing the difficulty of operation. In addition, since the contents of the imidazole-based curing agent or the anhydride-based curing agent were too low, the degree of the crosslinking of the temporary adhesive compositions were insufficient, resulting in the thermal degradation temperature of less than 330° C., which was prone to cause wafer shattering during the manufacturing process.

As shown in Comparative Examples 8 and 10, when the content of the imidazole-based curing agent was greater than 4 weight percent or the content of the anhydride-based curing agent was greater than 5 weight percent, the excess imidazole-based curing agent or anhydride-based curing agent caused the thermal degradation temperature of the temporary adhesive layer to be less than 330° C. In addition, the imidazole-based curing agent or the anhydride-based curing agent that did not participate in the reaction in the temporary adhesive composition would gasify during the high-temperature process, which led to wafer shattering.

As shown in Comparative Example 11, when the content of the black dye was less than 0.1 weight percent, the shielding ability of the temporary adhesive composition was insufficient to protect the device wafer from damage after the laser de-bonding process. As shown in Comparative Example 12, when the content of the black dye was greater than 20 weight percent, although the device wafer could be protected from damage, the roughness of the temporary adhesive composition would increase, which reduced the adhesion of the temporary adhesive layer to the substrate.

In summary, the temporary adhesive layer of the present disclosure integrates multiple functions of laser shielding, laser de-bonding, and adhesion. Compared with the conventional methods for manufacturing semiconductor devices or display devices, the method for manufacturing semiconductor devices or display devices of the present disclosure does not need to form the conventional metal sacrificial layer and the conventional laser de-bonding layer, so the method of the present disclosure can reduce the process time and the process cost.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A temporary adhesive layer, wherein a thickness of the temporary adhesive layer ranges from 2 μm to 2000 μm, a light transmittance at 300 nm to 1064 nm for the temporary adhesive layer ranges from 0.1% to 1%, and a storage modulus of the temporary adhesive layer is at least 0.1 MPa after the temporary adhesive layer is heated at 50° C. to 300° C. for at least 10 minutes, wherein an adhesion of the temporary adhesive layer to a substrate is greater than 180 N/cm².

2. The temporary adhesive layer of claim 1, wherein the substrate is a copper substrate, a glass substrate, a polyimide substrate, or a silicon substrate.

3. The temporary adhesive layer of claim 1, wherein a thermal degradation temperature (Td1) at 1% weight loss of the temporary adhesive layer is greater than 330° C.

4. The temporary adhesive layer of claim 1, wherein an etch rate of the temporary adhesive layer in an alkaline cleaning solution ranges from 2.5 μm/min to 5.1 μm/min.

5. A multilayer structure, comprising:
a first release layer;
a second release layer; and
the temporary adhesive layer of claim 1, wherein the temporary adhesive layer is disposed between the first release layer and the second release layer, the temporary adhesive layer has a first surface and a second surface that are opposite to each other, the first surface contacts the first release layer, the second surface contacts the second release layer, and a complex viscosity of the temporary adhesive layer is not greater than 940 Pa·s.

6. The multilayer structure of claim 5, wherein an absorption wavelength of the temporary adhesive layer ranges from 308 nm to 1064 nm.

7. The multilayer structure of claim 5, wherein there is no other layer between the temporary adhesive layer and the first release layer, and there is no other layer between the temporary adhesive layer and the second release layer.

8. A temporary adhesive composition used for forming the temporary adhesive layer of claim 1, based on a total weight of the temporary adhesive composition as 100 weight percent, comprising:
thirty weight percent to fifty weight percent of a base resin, wherein the base resin is selected from the group consisting of an alkyd resin, a phenolic resin, an acrylic resin, and a polyester resin;
seventeen weight percent to forty weight percent of a hydrocarbon-based polymer resin;
0.1 weight percent to 20 weight percent of black dye;
0.5 weight percent to 4 weight percent of an imidazole-based curing agent;
0.5 weight percent to 5 weight percent of an anhydride-based curing agent; and
three weight percent to five weight percent of an epoxy resin, wherein a complex viscosity of the temporary adhesive composition is not greater than 940 Pa·s.

9. The temporary adhesive composition of claim 8, wherein the acrylic resin is pentaerythritol triacrylate.

10. The temporary adhesive composition of claim 8, wherein a hydroxyl value of the polyester resin is at least 20 mg KOH/g.

11. The temporary adhesive composition of claim 8, wherein a molecular weight of the polyester resin is at least 5000 g/mole.

12. The temporary adhesive composition of claim 8, wherein the polyester resin comprises a benzene ring.

13. The temporary adhesive composition of claim 8, wherein the polyester resin is a polyester polyol resin with a molecular weight of 5000 g/mole.

14. The temporary adhesive composition of claim 8, wherein a particle diameter of the black dye ranges from 10 nm to 50 nm.

15. The temporary adhesive composition of claim 8, wherein an absorption wavelength of the black dye ranges from 300 nm to 1064 nm.

16. A packaging method for a device, comprising:
providing a first component;
providing a second component;
providing the multilayer structure of claim 5;
peeling off the first release layer of the multilayer structure to expose the first surface of the temporary adhesive layer;
after peeling off the first release layer, performing a first lamination process such that the first surface of the temporary adhesive layer is adhered to the first component;
after performing the first lamination process, peeling off the second release layer of the multilayer structure to expose the second surface of the temporary adhesive layer; and
after peeling off the second release layer, performing a second lamination process such that the second surface of the temporary adhesive layer is adhered to the second component to obtain the device.

17. The packaging method for the device of claim 16, wherein a lamination pressure of the first lamination process ranges from 0.5 kg/cm² to 100 kg/cm², a lamination temperature of the first lamination process ranges from 100° C. to 350° C., and a lamination time of the first lamination process ranges from 10 seconds to 200 minutes.

18. The packaging method for the device of claim 16, wherein a lamination pressure of the second lamination process ranges from 0.5 kg/cm² to 100 kg/cm², a lamination temperature of the second lamination process ranges from 100° C. to 250° C., and a lamination time of the second lamination process ranges from 10 seconds to 200 minutes.

19. The packaging method for the device of claim 16, wherein the first component is a carrier wafer, and the carrier wafer is a glass substrate, a silicon substrate, an organic substrate, or an inorganic substrate.

20. The packaging method for the device of claim 16, wherein the second component is a device wafer, and the device wafer is an integrated substrate with molding compound or with an array copper pillar structure.
